(19) United States
(12) Patent Application Publication
(10) Pub. No.: US 2016/0208902 A1
(43) Pub. Date: Jul. 21, 2016

(54) CAM FOLLOWER

(71) Applicants: Benoît HAUVESPRE, Saint Etienne de Chigny (FR); Guillaume JOUANNO, Plouha (FR)

(72) Inventors: Benoît HAUVESPRE, Saint Etienne de Chigny (FR); Guillaume JOUANNO, Plouha (FR)

(73) Assignee: Aktiebolaget SKF, Goteborg (SE)

(21) Appl. No.: 14/992,056

(22) Filed: Jan. 11, 2016

(30) Foreign Application Priority Data
Jan. 16, 2015 (EP) 15305039.8

(51) Int. Cl. F16H 53/06

(52) U.S. Cl. CPC F16H 53/06

(57) ABSTRACT

A cam follower (configured to be driven by a cam) includes a tappet, a radial bore inside which a shaft is mounted, and a roller that is rotatably mounted around the shaft for providing a rolling contact with the cam. At least one of the inner bore and a radial surface of the shaft is coated with at least one of an anti-friction and a wear resistance coating layer. The coating layer includes polyetheretherketone.

### CROSS REFERENCE TO RELATED APPLICATION

This is a Non-Provisional Patent Application, filed under the Paris Convention, claiming the benefit of Europe (EP) Patent Application Number 15305039.8, filed on 16 Jan. 2015 (16.01.2015), which is incorporated herein by reference in its entirety.

### TECHNICAL FIELD OF THE INVENTION

The invention concerns a cam follower designed for cooperating with a cam in order to provide a reciprocating motion. For instance, this reciprocating motion may be used in the internal combustion engine of a vehicle.

### BACKGROUND OF THE INVENTION

Engine manufacturers strive to improve performance of internal combustion engines by maximizing the conversion of chemical energy into mechanical energy. The conversion efficiency may be improved by reducing friction between the moving parts of the engine. To this end, cam followers are designed for providing a rolling contact with the cam because a rolling contact induces less fiction than a sliding contact. Cam followers then include a rocker arm at the end of which a roller is located for contacting the cam. The roller is rotatably mounted around a shaft that is mounted inside a radial bore.

A further improvement is disclosed in JP-A-2005030569. It consists in applying an antifriction and wear resistant coating on the radial surface of the shaft. This coating may include Molybdenum disulfide (MoS2), tungsten disulfide (WS2) or fluorine polymer.

One may also think about diamond-like carbon (DLC) for coating the radial surface of the shaft. However, diamond-like carbon coating needs to be applied under high temperature conditions and requires pivoting the shaft around its revolution axis. Furthermore, it is quite expensive.

### SUMMARY OF THE INVENTION

The invention intends to solve these drawbacks by proposing a cam follower with which the anti-friction and/or wear resistance coating is easier to apply and cheaper.

To this end, the invention concerns a cam follower, comprising a tappet, configured to be driven by a cam, a radial bore inside which a shaft is mounted, and a roller, that is rotatably mounted around the shaft for providing a rolling contact with the cam, at least the inner bore or a radial surface of the shaft being coated with an anti-friction and/or wear resistance coating layer. The coating layer includes polyetheretherketone.

Thanks to the invention, a coating made of polyetheretherketone is easy to apply as it may be applied, through spraying, under low temperature conditions. Further, polyetheretherketone is less expensive than diamond-like carbon and provides a better sliding of the shaft inside the radial bore.

Further aspects of the cam follower which are advantageous but not compulsory are specified here-below:
The thickness of the coating layer is between 1 and 5 μm, preferably equal to 3 μm.
The coating layer is reinforced with glass or carbon fibers.
The coating includes polytetrafluoroethylene.
The radial bore is delimited by the roller.
The cam follower further comprises a bushing radially interposed between the roller and the shaft.
The radial bore is delimited by the bushing.

### BRIEF DESCRIPTION OF THE DRAWINGS

The invention will now be explained in correspondence with the figures, and as an illustrative example, without restricting the object of the invention. In the figures:

FIG. 1 is a schematic view of a cam assembly, comprising a camshaft cooperating with a cam follower according to the invention;

FIG. 2 is a section of the cam follower of FIG. 1, according to a first embodiment of the invention; and

FIG. 3 is a section similar to FIG. 2, representing a cam follower according to a second embodiment of the invention.

### DETAILED DESCRIPTION OF DRAWINGS

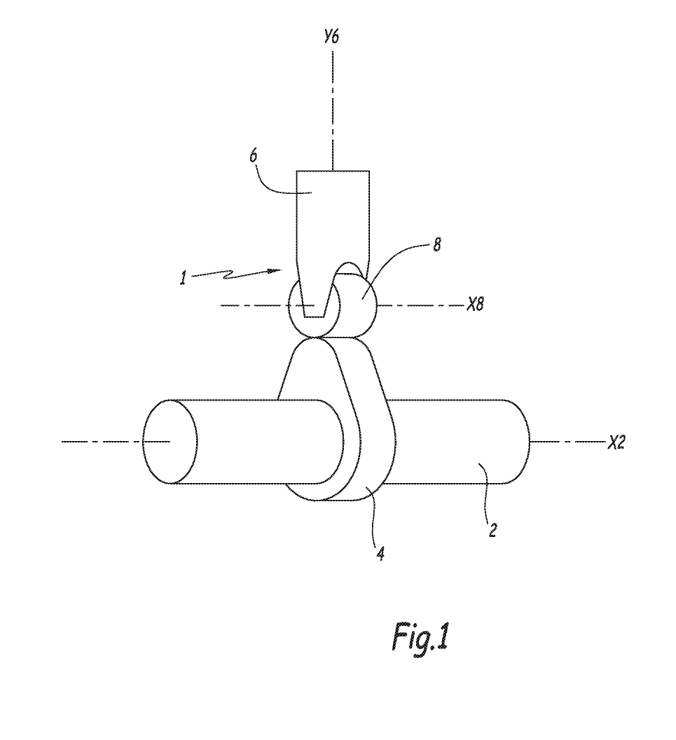

FIG. 1 represents a cam assembly comprising a camshaft 2 configured to rotate around a revolution axis X2. An ovoid cam 4 is secured around the cam shaft 2 and cooperates with a cam follower 1. Cam follower 1 includes a tappet 6 extending along an axis Y6 that is perpendicular to axis X2. Tappet 6 is configured to be driven in translation by cam 4. More precisely, cam follower 1 cooperates with cam 4 to transform the rotating motion of cam 4 into a reciprocating motion along axis Y6. For instance, cam follower 1 may be used in an internal combustion engine of a vehicle. Cam follower 1 includes a roller 8 for providing a rolling contact with cam 4.

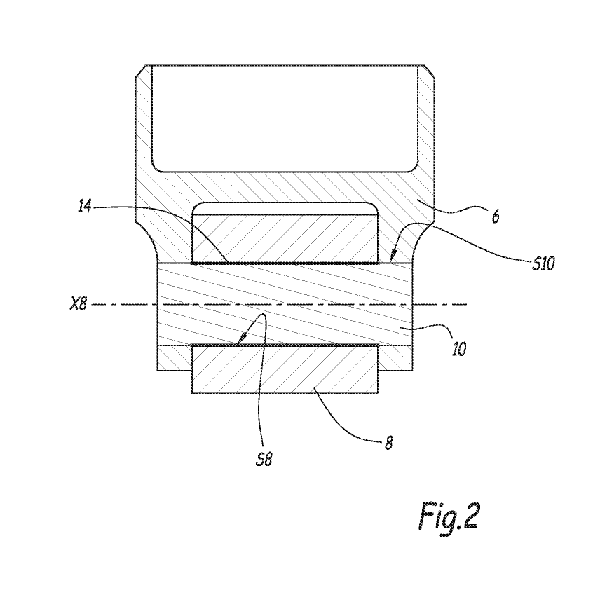

Roller 8 is tubular with a circular cross section and is rotatably mounted around a cylindrical shaft 10 that is formed at one end of tappet 6. Shaft 10 is of circular cross section and is secured to tappet 6, which means that it is motionless. More precisely, both extremities of shaft 10 are fixedly attached to tappet 6. Tappet 6 delimits holes for receiving shaft extremities. These holes may be blind holes or through holes. Shaft extremities may be welded, glued or caulked inside these holes. Roller 8 is configured to rotate around an axis X8 parallel to axis X2 when contacting cam 4. This axis X8 is superimposed with a revolution axis of shaft 10. A shown on FIG. 2, roller 8 delimits a radial bore S8 inside which shaft 10 is mounted. Radial bore S8 is defined by a cylindrical surface of circular cross section.

The radial surface S10 of shaft 10 is coated with a layer 14 by anti-friction coating. This coating layer 14 also provides wear resistance. It includes polyetheretherketone.

PEEK coating layer is easy and cheap to apply as it may be applied through spraying under low temperature conditions. The thickness of the PEEK coating layer 14 is between 1 and 5 μm, preferably equal to 3 μm.

The PEEK coating may be reinforced with glass or carbon fibers and may include polytetrafluoroethylene (PTFE) to lubricate the contact of shaft 10 inside bore S8. PTFE then provides a better sliding between roller 8 and shaft 10 and increases cam follower life-time. The coating may also be applied on the radial bore S8 of roller 8.

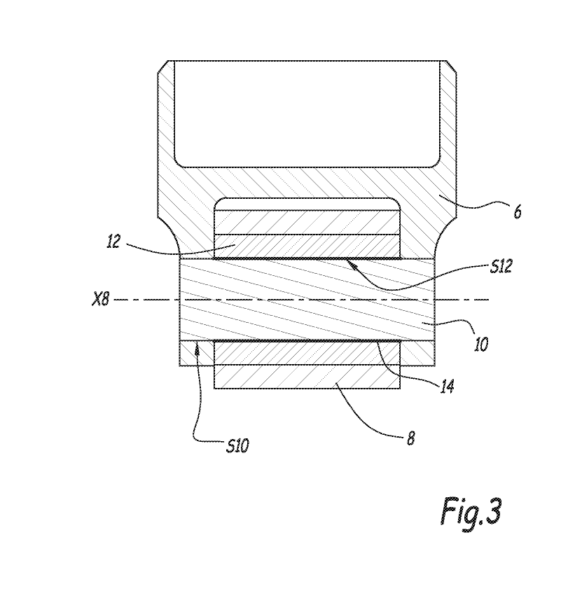

FIG. 3 represents a second embodiment of a cam follower according to the invention.

Cam follower of FIG. 3 differs from that of FIG. 2 in that it further includes a bushing 12 that is radially interposed between roller 8 and shaft 10. As a result, shaft 10 is mounted within a radial bore S12 delimited by bushing 12. An anti-friction coating layer may be applied on the radial surface S10 of shaft 10 and/or on the radial bore S12 of bushing 12, as shown by layer 14 on this figure. On FIGS. 2 and 3, the thickness of layer 14 is exaggerated, for the sake of clearly showing this layer 14.

In a non-represented alternative embodiment, the same cam follower may be used in a different cam assembly. For instance, cam follower 1 may be used in a wedge cam assembly or in a barrel cam assembly.

The embodiments and alternative embodiments mentioned here-above may be combined together to generate new embodiments of the invention.

what is claimed is:

1. A cam follower, comprising:
a tappet, configured to be driven by a cam;
a radial bore inside which a shaft is mounted; and
a roller, which is rotatably mounted around the shaft for providing a rolling contact with the cam, at least the inner bore or a radial surface of the shaft being coated with an anti-friction and/or wear resistance coating layer,
wherein the coating layer includes polyetheretherketone (PEEK).

2. The cam follower according to claim 1, wherein the thickness of the coating layer is between 1 and 5 μm.

3. The cam follower according to claim 1, wherein the thickness of the coating layer is equal to 3 μm.

4. The cam follower according to claim 1, wherein the coating layer is reinforced with one of glass or carbon fibers.

5. The cam follower according to claim 1, the coating further includes polytetrafluoroethylene (PTFE).

6. The cam follower according to claim 1, wherein the radial bore is delimited by the roller.

7. The cam follower according to claim 1, the cam follower further comprising a bushing radially interposed between the roller and the shaft.

8. The cam follower according to claim 7, wherein the radial bore is delimited by the bushing.
